(19) United States
(12) Patent Application Publication
(10) Pub. No.: US 2008/0281665 A1
(43) Pub. Date: Nov. 13, 2008

(54) Automated Calendar Concierge

(75) Inventor: Robert E. Opaluch, East Providence, RI (US)

Correspondence Address: VERIZON;PATENT MANAGEMENT GROUP, 1515 N. COURTHOUSE ROAD, SUITE 500, ARLINGTON, VA, 22201-2909, US

(73) Assignee: VERIZON LABORATORIES, INC., WALTHAM, MA (US)

(21) Appl. No.: 11/745,530

(22) Filed: May 8, 2007

(51) Int. Cl. G06F 17/30; G06F 17/00; G06F 9/46

(52) U.S. Cl. 705/9; 707/104.1

(57) ABSTRACT

A method and system of an embodiment of the present disclosure may include receiving data from a calendar client at a network element communicatively coupled to a network wherein the data comprises information relating at least in part to unscheduled time for a user associated with the calendar client, searching a database for at least one event offering corresponding to the unscheduled time, and sending the at least one event offering to the calendar client. The method and system may include ranking or filtering event offerings based at least in part on preferences of a calendar client user.

### BACKGROUND INFORMATION

People have an ever increasing choice of entertainment offerings. People may look up and research different options but filtering through the offerings often means that they settle for a less desired option because of their lack of awareness of a superior choice. Peoples' free time is scarce and notice of entertainment options is frequently lost in the clutter of other offerings. Additionally, people frequently would like to spend a portion of their free time with family, friends, co-workers, clients or other associates, but find it difficult to coordinate schedules, preferences and the availability of entertainment offerings to agree upon a mutually desirable entertainment option.

### BRIEF DESCRIPTION OF THE DRAWINGS

In order to facilitate a fuller understanding of the exemplary embodiments of the present inventions, reference is now made to the appended drawings. These drawings should not be construed as limiting, but are intended to be exemplary only.

FIG. 1 is an automated calendar concierge system, in accordance with an exemplary embodiment of the disclosure;

FIG. 2 is depicts a method for implementing an automated calendar concierge system, in accordance with an exemplary embodiment of the disclosure;

FIG. 3A is an automated calendar concierge system, in accordance with an exemplary embodiment of the disclosure; and

FIG. 3B is an automated calendar concierge system, in accordance with an exemplary embodiment of the disclosure.

### DETAILED DESCRIPTION OF PREFERRED EMBODIMENTS

An exemplary embodiment of the present invention provides an automated calendar concierge system to one or more calendar clients. The automated calendar concierge system may present entertainment offerings corresponding to unscheduled time of one or more users of an automated calendar concierge system.

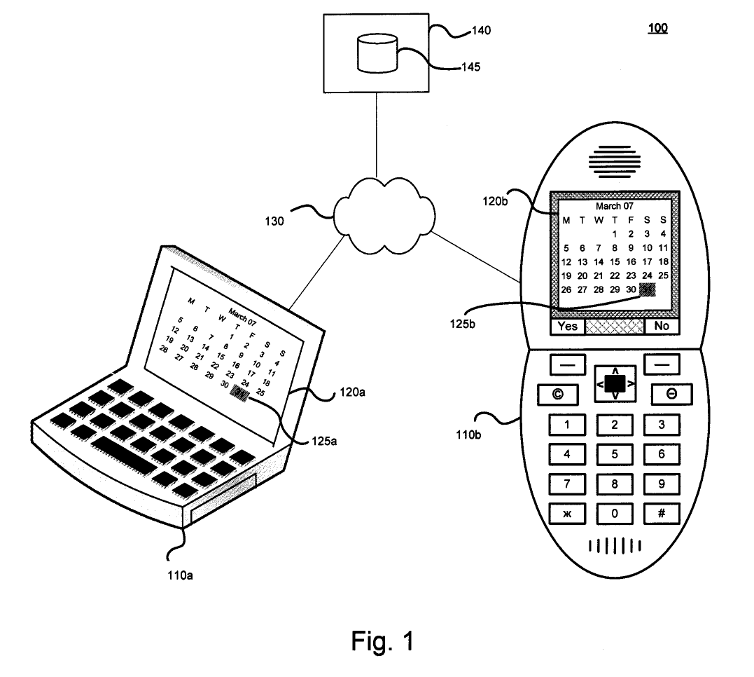

Referring to FIG. 1, an automated calendar concierge system in accordance with an exemplary embodiment of the disclosure is illustrated. System 100 illustrates an exemplary system for supporting an automated calendar concierge system. It is noted that System 100 is a simplified view of a network and may include additional elements that are not depicted. As illustrated, Calendar Concierge Client 110a and 110b may be wireline phones, cellular phones, mobile phones, or satellite phones, Personal Digital Assistants (PDA), computers, handheld MP3 players, handheld video players, personal media players, watches, gaming devices, GPS navigation devices, televisions, printers or other devices capable of receiving an event offering. Calendar Concierge Client 110a may contain a Calendar Display 120a in which a user may enter or receive schedule information. Calendar Concierge Client 110a may be operatively connected to Network 130. Network 130 may contain one or more Network Elements 140. Network Element 140 may contain or be operatively connected to Calendar Concierge Database 145. One or more additional calendar concierge clients, such as Calendar Concierge Client 110b, may be operatively connected to Network 130. Calendar Concierge Client 110b may contain Calendar Display 120b.

In some embodiments a user of Calendar Concierge Client 110a may be a person desiring to view one or more event offerings for their unscheduled time. Unscheduled time may include one or more calendar time slots of Calendar Concierge Client 110a which may not contain any scheduled events. In other embodiments unscheduled time may include one or more calendar time slots of Calendar Concierge Client 110a which may be marked by a user of Calendar Concierge Client 110a as unscheduled or unscheduled time may include one or more calendar time slots selected by a user for event offerings. For example, Calendar Slot 125a of Calendar Display 120a may indicate that Mar. 31, 2007 is available for suggested event offerings. Unscheduled time may be indicated by highlighted timeslots, shaded timeslots, timeslots containing one or more icons or other indicators.

Calendar Concierge Client 110a may transmit and/or receive data to and/or from Network 130 representing schedule information. The calendar data may be transmitted and/or received utilizing a standard telecommunications protocol or a standard networking protocol. For example, one embodiment may utilize Session Initiation Protocol (SIP). In other embodiments, the calendar data may be transmitted and/or received utilizing other Voice Over IP (VOIP) protocols or other protocols. For example, calendar data may also be transmitted and/or received using Wireless Access Protocol (WAP), Multimedia Messaging Service (MMS), Enhanced Messaging Service (EMS), Short Message Service (SMS), Global System for Mobile Communications (GSM), other Transmission Control Protocol/Internet (TCP/IP) Protocols, iCalendar protocol, RFC 2445 compliant protocols, calendar protocols or other protocols suitable for transmitting and receiving calendar data. Calendar Data may be transmitted and/or received wirelessly or may utilize cabled network or telecom connections such as an Ethernet RJ45/Category 5 Ethernet connection, a fiber connection, a traditional phone wireline connection, a cable connection or other wired network connection. Calendar Concierge Client 110a may use standard wireless protocols including IEEE 802.11a, 802.11b and 802.11g. Calendar Concierge Client 110a may also be connected to Network 130 via protocols for a wired connection, such as an IEEE Ethernet 802.3.

Network 130 may be a local area network (LAN), a wide area network (WAN), the Internet, cellular networks, satellite networks or other networks that permit that transfer and/or reception of data to and/or from Calendar Concierge Client 110a. Network 130 may utilize one or more protocols of Calendar Concierge Client 110a or Calendar Concierge Client 110b. Network 130 may translate to or from other protocols to one or more protocols of Calendar Concierge Client 110a or Calendar Concierge Client 110b. Calendar data transmitted through Network 130 may be received by Network Element 140.

Network Element 140 may be one or more servers (or server-like devices), such as a Session Initiation Protocol (SIP) server. Network Element 140 may include one or more processors (not shown) for recording, transmitting, receiving, and or storing data. Although Network Element 140 is depicted as one server, it should be appreciated that the contents of Network Element 140 may be combined into fewer or greater numbers of servers (or server-like devices) and may be connected to one or more data storage systems. For example, Network Element 140 may be connected to one or more Calendar Concierge Databases 145. Furthermore, the server may be local, remote, or a combination thereof to Calendar Concierge Databases 145. Additionally, portions of Network Element 140 functionality may be implemented on Calendar Concierge Client 110a.

Network Element 140 may provide event information for Calendar Concierge Client 110a. Network Element 140 may query Calendar Concierge Database 145 to generate a list of available entertainment offerings for Calendar Concierge Client 110a. Calendar Concierge Database 145 may be a component of Network Element 140 or Calendar Concierge Database 145 may be operatively connected to Network Element 140.

Network Element 140 may provide application programming interfaces (APIs), interface tables, remote procedure calls (rpcs), interface tables, web services, Extensible Markup Language (XML) based interfaces, Simple Object Access Protocol (SOAP) based interfaces and other interfaces for sending or receiving event information. Network Element 140 may receive data from event providers, event marketers, event sponsors, directory services, rating services or event information services. Network Element 140 may store event information in Calendar Concierge Database 145. Network Element 140 may parse, index or otherwise transform event related data. Transforming event related data may include categorizing events by type, theme, location, cost, rating, preference of one or more calendar concierge clients, or other category. Some event information may be provided on a subscription or other cost basis. Some event information may be sponsored by an advertiser, a promoter or other sponsor.

In one or more embodiments, Network Element 140 may query one or more external sources of information to gather event information or facilitate event transactions. For example, may gather information from a search engine or from a user specified web site. Additionally, Network Element 140 may access other sources of information to purchase event tickets, to obtain traffic information, to obtain weather information or to obtain other event related information.

Network Element 140 may gather information for a range of events including but not limited to: movies at theaters, television offerings, subscription based television offerings, pay per view offerings, sports events; concerts, parades, sales, lectures, classes, religious services, shows, community events, school events, museum events, gallery events, political events, organization events, restaurant reservations, plays, alumni events, and meetings. Events may include but are not limited to media of a calendar client user. For example, events may include entertainment owned or leased by a calendar concierge user such as but not limited to, movie DVDs, music tracks, CDs, MP3s, home videos, podcasts, Internet accessible videos, Internet accessible music, electronic games, board games or other entertainment.

Furthermore, Network Element 140 may gather event related information such as weather related information, traffic related information, directions to one or more events, and ratings and/or reviews of one or more events. For example, Network Element 140 may gather or be provided with restaurant reviews, such as Zagat's Survey®, movie reviews, TV Channel Guides or other comparison guides. Network Element 140 may gather cost comparison related information. For example, if the event is a sale, Network Element 140 may gather references to and/or data from a cost comparison web site or information service for competitive products.

Calendar Concierge Database 145 may store event information and related data. Calendar Concierge Database 145 may store event related information gathered by Network Element 140 and/or event related information loaded from other sources. Event related data may include event times, dates, durations, locations, directions to an event, travel times costs of an event, performers of an event, parking and/or other transportation related information and other event related data. Calendar Concierge Database 145 may store information on discounts, coupons, specials, sales and other pricing information. Calendar Concierge Database 145 may be contained on Network Element 140 or may be operatively connected to Network Element 140. In one or more embodiments, Calendar Concierge Database 145 or a subset of Calendar Concierge Database 145 may be contained on Calendar Concierge Client 110a. In such an embodiment, Calendar Concierge Client 110a may receive updates of event related data from Network Element 140 and may transmit preference related data to Network Element 140.

Additionally, Calendar Concierge Database 145 may store one or more preferences of a Calendar Concierge Client 110a user. Preferences may be specified by a user or by be tracked by maintaining a history of past purchases, past schedules, past invitations and other historical event transaction related information. Preferences may include costs of an event, accepted payment methods for an event, locations, travel times, availability, type of event offering, one or more performers of an event offering, genre of an event offering, style of an event offering, sponsors of an event offering, time of event offering, duration of an event offering or other factors. Preferences specified by a user may enable a user to rank an event by one or more of the above factors. User specified preferences may enable a user to rank the importance of one or more factors generally, independent of an event.

User specified preferences may specify particular events, such as events related to a sports team, a performer, a band, an author or other performer. User specified preferences may specify a source of events, a sponsor of events, an event facility, a club or other event venue. For example, user specified preferences may specify a preference for events at jazz club, or for games of a favorite team. User specified preferences may specify ratings for event offerings. For example, a user may specify that event offerings may be rated by an expert or a reviewer as being within a certain quality range. User specified preferences may indicate event offering preferences based on a users past preferences and may use historical data of past event offerings. User specified preferences may specify a web site, blog, list server or other form of electronic event notification to monitor for event information.

User specified preferences stored by Calendar Concierge Database 145 may include information such as one or more home locations, work locations, delivery locations or other locations. User locations may be specified via Calendar Concierge Client 110a so that it may be calculated that at a given time a user is typically at a given location. User specified locations may include current location which may be a current or recent location based on Global Positioning System (GPS) data received from Calendar Concierge Client 110a. Event offerings may thus be filtered based at least in part on travel time from a user location to an event location, travel distance, traffic and weather according to scheduled user location. Event offerings may not be presented if the travel time plus the event duration exceeds the unscheduled time available. A user may change the location used to filter event offerings or may specify that the user location be ignored.

User specified preferences stored by Calendar Concierge Database 145 may provide blocking or filtering criteria. A user may provide one or more filtering criteria to exclude events from being presented. A user may block event offerings based on artists, performers, locations, facilities, event types, ratings, parental controls, violence level, sexual content, political biases, tastefulness (which may be as measured by a critic or a ratings organization, e.g. movie ratings disclosing nudity, violence, sex, drug use or other questionable content), style, genre, language or other event related criteria. A user may specify limits such as cost limits, travel distances, event durations or other limitations. A user may block scheduling for specific times of the day, week, year or other reoccurring period so that events may not be offered for that time frame. For example, a user may block all event offerings or non-work related event offerings for 9 A.M. to 5 P.M. Monday through Friday without requiring a user to schedule work events for the entire time period. A user may also block an event type such as hockey related events.

User specified preferences may be stored in Calendar Concierge Database 145 and may be retrieved by Network Element 140 when generating a list of available event offerings. Network Element 140 may use one or more user specified preferences to filter, sort, index, order, and perform other data processing on a list of event preferences.

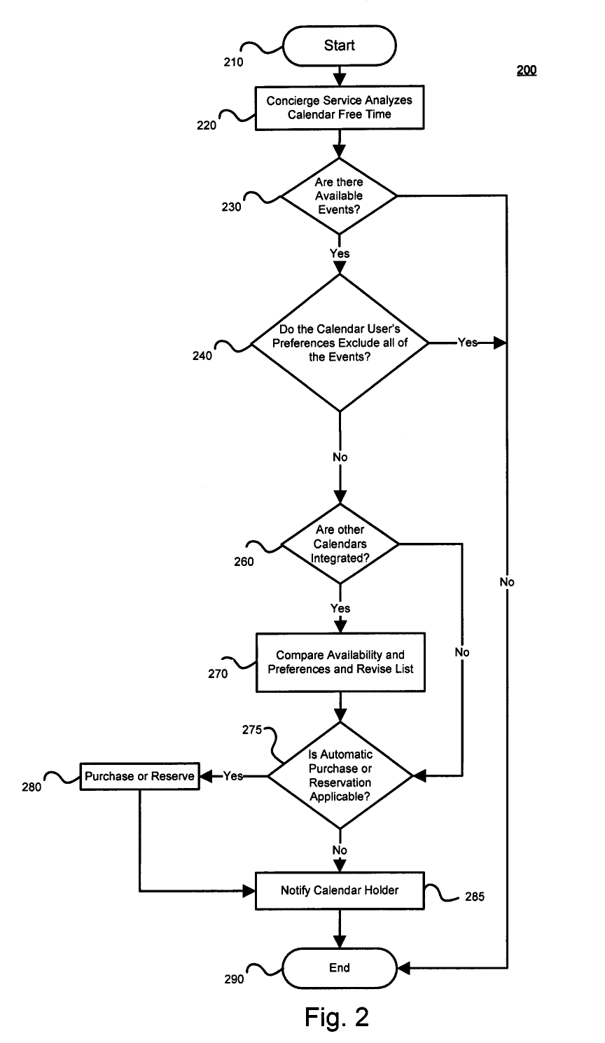

Network Element 140 may provide a user of Calendar Concierge Client 110a with a list of available event offerings corresponding to Calendar Slot 125a. As explained in more detail in reference to FIG. 2 below, event offerings may be filtered, ranked, ordered, or presented in another way designed to emphasize the offerings which reflect the preferences of a user of Calendar Concierge Client 110a.

A user of Calendar Concierge Client 110a may further be provided with event related information, such as directions to an event, weather for the time of an event, seating charts for a facility hosting an event, seat availability for an event and other event related information.

In other embodiments, a user of Calendar Concierge Client 110a may request event offerings for a specified calendar time slot. The request may override a user specified preference blocking receipt of event offerings for that time slot. For example, a user may specify a Tuesday from 3-5 PM which may ordinarily be blocked according to a user's preferences. This may enable a user to search for event offerings for a day off. A user may specify one or more preferences for a particular search for event offerings that differ from saved preferences. This may enable a user to see event offerings that may be purchased or reserved for a gift or other reasons.

In one or more embodiments, a user of Calendar Concierge Client 110a may wish to schedule an event with or for another calendar concierge user. Calendar Concierge Client 110b may be a calendar concierge client for a second calendar concierge user. Calendar Slot 125b of Calendar Display 120b may indicate that Mar. 31^{st}, 2007 is available for suggested event offerings. If a user of Calendar Concierge Client 110b has shared their calendar with a user of Calendar Concierge Client 110a, the user of Calendar Concierge Client 110a may receive event offerings corresponding to free time for both users. The event offerings may represent events that satisfy both sets of user preferences.

In one or more embodiments, event offerings may represent introductions to other individuals. Calendar Concierge Client 110a may be presented with information regarding other individuals who have similar interests or other common connections. Event offerings may include contact information for individuals for common connections including dating, alumni associations, carpooling, timeshares, splitting season passes, networking, sports teams or other common connections. For example, event offerings could present individuals who are looking for a golf partner for a tee time, an individual with a similar commute looking for a carpool, an individual looking to share season passes for a football team or other common interests. The event offering may be presented to one or more calendar concierge users and may allow them to share contact information such as email addresses, phone numbers, addresses, calendars, and/or other event offering details. Calendar Concierge Client 110a may be able to specify event preferences for such event offerings. For example, Calendar Concierge Client 110a may specify a departure location, a destination location, a departure time range and a return time range to facilitate specific event offerings regarding a car pool. In another example, Calendar Concierge Client 110a may be able to specify interests, geographic region, age range, and/or other criteria which may be used to present contact information individuals with similar criteria specified in a dating, networking or other profile.

A user of Calendar Concierge Client 110b may share calendar information and/or grant access to calendar information by identifying a user of another Calendar Concierge Client with whom they desire to share calendar information. Calendar Concierge Client 110b may identify a user by one or more attributes including: the network address of another user, a phone number associated with another user, an email address associated with another user, or other factors. Network Element 140 may receive sharing information and may store sharing information in Calendar Concierge Database 145. Calendar Concierge Database 145 may contain a list of one or more authorized users, a list of one or more blocked users, or both. The lists may identify users by one or more attributes, such as phone number, network address, name, login name, or other identifying attribute. Calendars may also be shared to a group. Groups may be defined by an individual having administrative access to Calendar Concierge Database 145. Groups may be identified by network characteristics or by other common characteristics. For example, calendars may be shared among everyone in a same subnet, a same local area network, or other group identifier. Groups may be defined by entering one or more attributes used to define an individual into a group list for every individual in the group.

Referring to FIG. 1 again, Calendar Concierge Database 145 may contain identifying system attributes such as machine name, Media Access Control (MAC) address, network address or other identifying attributes. Network Element 140 may query Calendar Concierge Database 145 and may authorize access by verification of a password, an encrypted key, a code or other validation indicator.

Calendar Concierge Client 110b may share their calendar information with family, friends, business associates or other individuals. Calendar Concierge Client 110b may provide different levels of access to different individuals, different groups or based on other criteria. Levels of access may give full access, read only access, read only access to only unscheduled time, or other levels of access. Access levels may be categorized by a type of association (e.g. administrator, user, family, friend, business, school, emergency services, police, parent, custodian, teacher and custom). Custom may include levels with one or more access permissions granted to the levels by an administrator.

Calendar Concierge Client 110b may receive an invitation to an event from Calendar Concierge Client 110a.

In one or more embodiments, if calendars are shared, Calendar Concierge Client 110a may send invitations to events to Calendar Concierge Client 110b. Invitations may be received by Calendar Concierge Client 110b as scheduled events on their calendar, as email notifications, as text message notifications, as voice mail notifications or as other notifications. An notification may require or request a user of Calendar Concierge Client 110b to confirm the event or may be only for notification purposes.

Calendar Concierge Client 110b may also have events scheduled in their calendar by Calendar Concierge Client 110a. Depending on the access level granted to Calendar Concierge Client 110a, these events may be optional, may require confirmation from Calendar Concierge Client 110b or they may be mandatory. For example, a parent may schedule events for a child. Calendar Concierge Client 110a may also view events scheduled for other users, cancel events scheduled for other users, reschedule events scheduled for other users and perform other actions on shared calendars depending on the access granted to Calendar Concierge Client 110a. For example, parents may also view events scheduled for a child. In one or more embodiments, Calendar Concierge Client 110a may maintain two or more calendars which may allow multiple users for a single client or may allow a user to maintain separate calendars for different purposes (e.g., work, school, social). Separate calendars on a single calendar concierge client may set with different access levels and different preferences.

If calendars are shared, a user of Calendar Concierge Client 110a may be able to set preferences for Calendar Concierge Client 110b. For example, a parent, using Calendar Concierge Client 110a, may be able to set parental controls for a child calendar filtering which event offerings are displayed to child. Events may be filtered on cost, rating of an event (e.g., Restricted, X-Rated, etc), location of an event, type of an event, time of an event, target audience, or other factors. A parent may also be able to view requested or scheduled events of a child. In another example, if Calendar Concierge Client 110a is used for work, a supervisor may be able to limit event offerings based on locations, costs, types of events or other factors. For example a supervisor may limit the seminars that may be scheduled based on cost, subject matter, location and/or other factors.

The various components of system 100 as shown in FIG. 1 may be further duplicated, combined and/or integrated to support various applications and platforms. Additional elements may also be implemented in the systems described above to support various applications.

Referring to FIG. 2, a method for implementing an inbound phone control system is illustrated, in accordance with an exemplary embodiment of the disclosure. According to one or more embodiments, method 200 may begin at block 210.

At block 220, the calendar concierge service may query and/or receive calendar data. For example, Network Element 140 of FIG. 1 may query Calendar Concierge Client 110a for calendar data. Network Element 140 may also receive calendar data sent from Calendar Concierge Client 110a. Calendar Data may include free time, scheduled time, preferences and other calendar data. Calendar data may be sent or received on a periodic basis, on an triggered basis (event-driven), in response to a user request, or for other reasons. For example, a user may delete a scheduled event which may trigger Calendar Concierge Client 110a to query for event offerings. In another example, a user may schedule a date such as a birthday, holiday or anniversary in a calendar which may trigger Calendar Concierge Client 110a to query for event offerings. Additionally, a user may request event offerings via the interface of Calendar Concierge Client 110a. Event offerings may be requested by pressing a function key, choosing a menu item, clicking on a button, giving a voice command or providing other input to Calendar Concierge Client 110a.

At block 230, the calendar concierge may query event data for events that fit the calendar data. Event data may be stored on Calendar Concierge Database 145 or events may be queried from other data sources. Event duration as well as travel time to and from an event may be considered when querying events. If there are available events the method 200 may continue at block 240. If no events are available, the method 200 may end at block 290.

At block 240, events may be filtered, ranked, and/or ordered based on one or more preferences of a user. For example, a user may specify blocked artists, performers, clubs, locations or other factors which may filter one or more events. In another example, a user may specify favorite types of movies in order of preference (e.g., comedy 1^{st}, action 2^{nd}, mystery 3^{rd}), favorite types of food in order, favorite sporting events in order or other events attributes in a ranking format. One or more events may be ranked or ordered based on user preferences. A user's preference history may cause an event similar to one previously chosen by a user to be ranked higher than an event never offered to a user. An event offered to a user previously and rejected may be filtered or ranked lower.

At block 260, the automated calendar concierge system may determine whether other calendar users have integrated calendars. In one or more embodiments if other calendars are integrated a user may be prompted to verify if the event offerings should be processed for one or more other users. If other calendars are integrated the method may continue at block 270. In one or more embodiments, a calendar concierge user may create additional sets of preferences. The additional sets of preferences may indicate the preferences of a user's spouse, friends, family, business associates or other contacts. This may allow a user to view event offerings that may be of interest to others even if the user does not have access to the other person's calendar. The additional sets of preferences may be labeled with a name or other contact information indicating who may be interested in event offerings generated by the set. If more than one set of preferences is available, the method 200 may continue at block 270. If no other calendars are integrated and/or no other preferences are provided the method 200 may continue at block 275.

At block 270, event offerings may be further processed for two or more integrated calendars. Event offerings may be filtered by available free time on the two or more integrated calendars. Event offerings may also be filtered, ranked, organized and processed according to preferences of one or more users of the shared calendars. A list of event offerings may be generated for common free time of two or more shared calendars. The list may include event offerings filtered, ranked and/or organized by preferences of one or more users of the shared calendars. The list of event offerings may include event offerings for other sets of preferences specified by a user. Event offerings may be customized by the sharing preferences of the one or more users of the calendars. For example, if a calendar is shared with another user under a work level of access, event offerings may be seminars or events categorized as work related.

At block 275, the automatic calendar concierge system may verify if one or more users have set preferences to automatically purchase or reserve one or more event offerings in the list. If one or more users have set their preferences to automatically purchase or reserve one or more event offerings, the method 200 may proceed to block 280. If no users have set their preferences to automatically purchase or reserve event offerings in the list, the method may continue at block 285.

At block 280, the automated calendar concierge may purchase or reserve one or more event offerings based on user preferences. For example, a user may have entered credit card information or other account information that may be used to purchase tickets for a favorite team whenever free time is available and tickets are available. The user may specify a price ceiling limiting the amount that may be spent automatically. The user may specify the number of tickets, seats or places to reserve or purchase automatically. The user may require a confirmation or authorization before the purchase is completed. The automated calendar concierge system may retrieve stored credit card information, debit card information, transaction card information, checking account information, Pay Pal® information, or other account information from Calendar Concierge Database 145 to complete the transaction.

At block 285, the calendar user may be notified of available event offerings or may receive confirmation of reserved, purchased or scheduled event offerings. Notification may occur by email, text message, voice mail, by scheduling the events in one or more users' calendars or by other notification means. Scheduled events may use a different display option, such as a different font, a different color, an icon or other display option to indicate that they are tentative. A calendar user may be notified by a pop-up menu or other alert when they are using their calendar. The menu may present a list of options for one or more free time slots and may allow a user to choose which items are scheduled in their calendar. Additionally, one or more items may indicate that they accommodate the schedule and/or preferences of another shared calendar user and may allow the first calendar user to send an invitation to one or more additional calendar users. Invitations may be sent via email, via the one or more additional users' calendars, via text message, via voicemail utilizing text to speech, or by other notification methods. Depending on the access level, a first calendar user may schedule events for one or more users.

In one or more embodiments, notification may include receipt of the event offering. For example, a user may receive a downloaded movie to one or more calendar clients capable of receiving such media. A user may also receive electronic media, digital video, digital audio, access to online games, access to online events, access to online seminars, audio books, text-to-speech, online tours, demonstrations, educational content and/or other data. A user may also receive streaming data at their calendar client at the scheduled time of the event.

At block 280, the method may end.

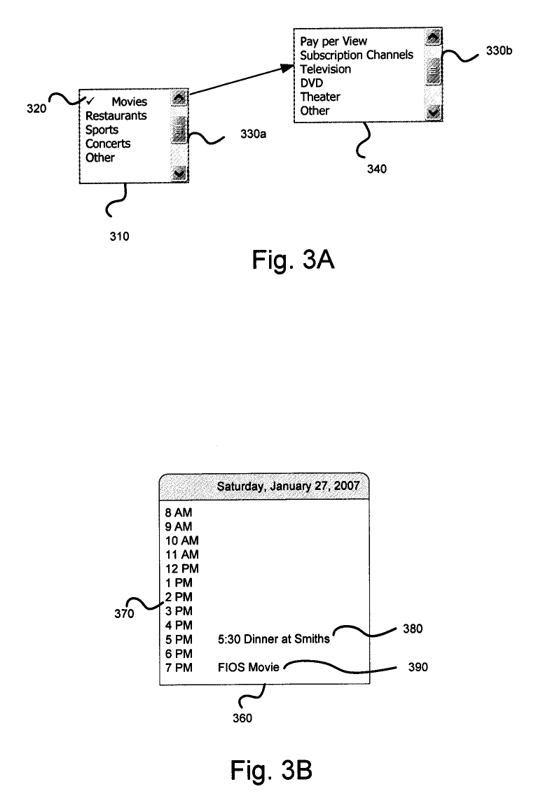

Referring to FIG. 3A, an automated calendar concierge system is illustrated, in accordance with an exemplary embodiment of the disclosure. FIG. 3A illustrates an exemplary system for displaying and selecting event offerings. As shown, event offerings may be presented in Menu 310. Menu 310 may be displayed to a user searching for event offerings, to a user reviewing event offerings for one or more free time slots, to a user responding to an event offering notification, or for other purposes. Menu 310 may contain one or more event offerings and may display one or more event categories to group the event offerings. Menu 310 may contain only event categories for which event offerings were found, may contain all event categories, or may contain only event categories specified by user preferences. Menu 310 may display an event category differently (e.g., font, color, underline, bold, blinking) or may display an indicator next to an event category if an event category contains events. If an event category chosen by a user contains no events for one or more timeslots, a user may be prompted to modify preferences to expand the range of available events. Menu 310 may contain Scrollbar 330a to facilitate the display of a long list. Menu 310 may give an Indicator 320 if an event category is chosen. A user may chose an event category by clicking on it using a pointing device, by entering it into a text field or by using another interface of Calendar Concierge Client 110a.

Once an event category is chosen Sub Menu 340 may be displayed. Sub Menu 340 may display one or more event offerings. Sub Menu 340 may contain Scrollbar 330b to facilitate the display of a long list. Event offerings may be selected by a user and may schedule an event offering in one or more calendars. Selection of an event offering may also enable a user to view event details, purchase tickets to an event, reserve an event, view shared calendar members who may be interested in an event, send invitations to an event to one or more shared calendar members and/or contacts, schedule reminders for an event or other event related actions. Event details may include, title, time, cost, performers, location, travel time, type, sponsor, seating charts, seating availability, reviews, directions, parking, weather and other event details. Selection of an event may provide contact information for an event such as links to a website, phone numbers, email addresses, addresses, contact names and/or other contact information.

A user may further sort, filter or organize event offerings by manually clicking and dragging events, by selecting events and deleting them, by specifying a sort order, by specifying filter criteria or by providing other event organization input. A user may specify sorting, filtering and other organizing criteria by selecting them from a menu, selecting them on a separate preferences screen, entering them in a text box, providing voice input, or by other input methods.

A user may be prompted for event related services. Event related services may include meals close to an event, transportation services to an event, gear for an event, guides for an event or other event related services. For example, if a golf time is scheduled, information for nearby stores selling golf equipment may be presented.

In one or more embodiments, an automated calendar concierge system may provide a top rated pick or a best guess for an event offering. This type of event offering interface may be in addition to a traditional navigational interface or may be an alternative to a navigational interface. The event offering may include multiple descriptive fields, video clips, audio clips, previews, reviews, purchase information, location information and/or other details. A calendar concierge user may be presented with an interface navigation prompt allowing them to navigate to a next pick, a similar pick or something different. For example, if a calendar concierge user is presented with an event offering of basketball tickets, if they choose next pick, they may be presented with another basketball game for which tickets are available. If a calendar concierge user chooses a similar pick they may be presented with pay per view coverage of the game. If the user chooses a prompt for something different, they may be presented with a different event type which may correspond to a second highest rated event type for a calendar concierge user. In the above example, a calendar concierge user may have preferences ranking basketball as a favorite event type and other activities such as a movie or a play as a second favorite event type. If the calendar concierge user chooses a prompt for something different they may be presented with a movie event offering. Offerings may also be more granular depending on the preferences specified, historical data available for a calendar concierge user, a profile of a calendar concierge user or other event ranking factors. For example, if a calendar concierge user is presented with an event offering for a Greek play on pay per view and they choose something different, they may be presented with an event offering for a modern play at a local stage. In addition to prompts for a next pick, similar pick and/or something different a calendar concierge user may be able to enter keywords or other criteria refining best pick event offerings. For example, a user may enter comedy in a keyword field, dropdown or other interface and may be presented with a best comedy event offering pick. The event offering may contain a video clip containing a preview, location information, time, cost and other event related information. Additionally, a calendar concierge may be able to specify other calendar concierge users with integrated calendars and a best pick may represent an event offering ranked according to the profiles and/or preferences of both users.

Referring to FIG. 3B, an automated calendar concierge system is illustrated, in accordance with an exemplary embodiment of the disclosure. FIG. 3A illustrates an exemplary system for displaying scheduled events. Calendar Display 360, displays scheduled events in a calendar of an automated calendar concierge user. Calendar Timeslots 370 are shown and the interval between the timeslots displayed and/or the range of timeslots displayed may be adjusted. Events 380 and 390 are shown as scheduled. A user of Calendar Display 360 may be able to select events 380 and 390 and perform various actions including but not limited to: obtaining more event information, sending an event invitation, setting an event reminder, cancelling an event, rescheduling an event, purchasing tickets for an event, reserving an event or other actions.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A method, comprising:
receiving data from a calendar client at a network element communicatively coupled to a network wherein the data comprises information relating at least in part to unscheduled time for a user associated with the calendar client;
searching a database for at least one event offering corresponding to the unscheduled time; and
sending the at least one event offering to the calendar client.

2. The method of claim 1 further comprising filtering the at least one event offering based at least in part on preferences of the user associated with the calendar client.

3. The method of claim 1 further comprising ranking the at least one event offering based at least in part on preferences of the user associated with the calendar client.

4. The method of claim 2 wherein the preferences of the user associated with the calendar client include at least one of:
a calendar client user's preference history; a rating of the event offering by a reviewer; a cost of the event offering; a location of the event offering; a time of the event offering; a type of the event offering; a performer of the event offering; and a sponsor of the event offering.

5. The method of claim 3 wherein the preferences of the user associated with the calendar client include at least one of:
a calendar client user's preference history; a rating of the event offering by a reviewer; a cost of the event offering; a location of the event offering; a time of the event offering; a type of the event offering; a performer of the event offering; and a sponsor of the event offering.

6. The method of claim 1 wherein event offerings include at least one of:
movies at one or more theaters; television offerings; subscription based television offerings; pay per view offerings; sports events; concerts; parades; sales; lectures; classes; religious services; shows; community events; school events; museum events; gallery events; political events; organization events; restaurant reservations; plays; alumni events; recorded music, live music, plays, children's events, video, Internet accessible media, games and meetings.

7. The method of claim 1 further comprising providing the event offerings to the user associated with the calendar client via an interface selected from the group of:
a web-based interface; a calendar client interface; a text message based interface; a television based interface; a phone interface, a printer; a handheld MP3 player; a gaming device; a GPS navigation device; a computer generated speech menu; a recorded menu; and an email based interface.

8. The method of claim 1 further comprising reserving at least one reservation for an event offering based at least in part on preferences specified by the user associated with a calendar client.

9. The method of claim 1 further comprising purchasing at least one ticket for an event offering based at least in part on preferences specified by the user associated with a calendar client.

10. The method of claim 1 further comprising:
integrating data from at least two calendar clients;
searching a database for at least one event offering corresponding to the unscheduled time of the integrated data; and
sending at least one integrated event offering to at least one user associated with the calendar client.

11. The method of claim 10 wherein integrated event offerings are presented to a user of a calendar client who has specified at least one user with whom to integrate event offerings.

12. The method of claim 11 wherein integrated event offerings are available after the at least one specified users grants access to calendar data associated with a calendar client of the at least one user.

13. The method of claim 12 wherein granting access to calendar data includes at least one of:
granting at least one level of access;
granting at least one type of access; and
granting access to at least one group.

14. The method of claim 13 wherein types of access include at least one of the following:
administrator, user, family, friend, business, school, emergency services, police, parent, custodian, teacher and custom.

15. A computer readable media comprising code to perform the acts of the method of claim 1.

16. A system, comprising:
a database for storing calendar event data; and
a network element communicatively coupled to a network wherein the network element is configured to: receive data from a calendar client wherein the data comprises information relating at least in part to unscheduled time for the calendar client,
to search the database for at least one event offering corresponding to the unscheduled time, and to send the at least one event offering to the calendar client.

17. The system of claim 16 wherein the at least one calendar client is implemented on at least one of the following: a cell phone; a computer; watch, gaming device, personal media player, TV, GPS navigation device and a personal digital assistant.

18. The system of claim 16 wherein the database stores at least one preference of the at least one user associated with a calendar client.

19. The system of claim 16 further comprising wherein the network element is configured to send one or more invitations for one or more event offerings to one or more contacts of a user associated with a calendar client.

20. The system of claim 16 further comprising: wherein the network element is configured to send the at least one event offering to at least one calendar client after at least one event has been selected wherein sending the at least one selected event includes at least one of:
sending electronic media, sending digital video, sending digital audio, providing access to online games, providing access to online events, providing access to online seminars, providing access to audio books, providing access to text-to-speech, providing access to online tours, providing access to demonstrations, providing access to educational content and sending streaming data.

21. The system of claim 16 further comprising wherein the at least one calendar client contains at least a portion of the database and the at least one calendar client is configured to search the portion of the database for event offerings corresponding to the unscheduled time and the at least one calendar client is further configured to present event offerings to at least one user associated with the calendar client.

22. The system of claim 21 further comprising wherein the at least one calendar client is configured to perform at least one of: filtering event offerings, sorting event offerings, ranking event offerings, and blocking event offerings.
